(19) United States
(12) Patent Application Publication
(10) Pub. No.: US 2024/0319053 A1
(43) Pub. Date: Sep. 26, 2024

(54) Automatic Fraction Collector

(71) Applicant: The University of Toledo, Toledo, OH (US)

(72) Inventor: Shi-He Liu, Toledo, OH (US)

(73) Assignee: The University of Toledo, Toledo, OH (US)

(21) Appl. No.: 18/606,189

(22) Filed: Mar. 15, 2024

Related U.S. Application Data
(60) Provisional application No. 63/453,195, filed on Mar. 20, 2023.

(51) Int. Cl. G01N 1/34; G01N 1/14; G01N 35/02

(52) U.S. Cl. CPC G01N 1/34; G01N 1/14; G01N 35/025

(57) ABSTRACT

An automatic fraction collector, methods of using the same, and systems including the same are described. The automatic fraction collector includes a sensor assembly able to detect liquid drops passing therethrough with light, where the sensor assembly is in the fluid flow path between a column and the point of collection of the liquid drops.

### RELATED APPLICATIONS

This application claims priority to U.S. Provisional Application No. 63/453,195 filed under 35 U.S.C. § 111(b) on Mar. 20, 2023, the disclosure of which is incorporated herein by reference in its entirety.

### STATEMENT REGARDING FEDERALLY SPONSORED RESEARCH

This invention was made with no government support. The government has no rights in this invention.

### BACKGROUND

Exosomes are small vesicles, or sacs, that are released from cells into the extracellular environment. Exosomes are formed by the budding of small vesicles from the endosomal compartment of cells, which is a part of the cell's endocytic pathway. Exosomes are spherical structures that typically measure 30-100 nanometers in diameter and contain a variety of biologically active molecules, including lipids, proteins, and RNA. Exosomes are studied for their possible use as diagnostic markers, therapeutic agents, and drug delivery vehicles. Compared to synthetic carriers such as nanoparticles and liposomes, the heterogeneity and endogeneity of exosomes demonstrate unique advantages in disease diagnosis and treatment. However, storage stability, low purity, and weak targeting of exosomes are limiting their clinical applications. Isolation and purification of exosomes are important for studying exosomal properties and applications.

Size exclusion chromatography (SEC) is the considered the best method for separating exosomes from most proteins, simultaneously recovering morphologically and functionally intact exosomes from plasma. However, the heavy labor and time needed for SEC are a challenge and limit its wide use. Manually processing SEC also increases the chance to make mistakes. A fully automatic machine is important for performing SEC isolation of exosomes accurately and routinely. There is a need for new and improved systems, devices, and methods for conducting SEC in an automated way.

### SUMMARY

Provided herein is an automatic fraction collector comprising a column; an injection device configured to introduce a fluid into the column; a nozzle in fluid communication with the column; a pinch valve assembly configured to allow and prevent flow through the nozzle on command; a sensor assembly comprising a body defining a channel therethrough, an IR emitter on a first side of the channel, and an IR detector on an opposing second side of the channel, wherein the sensor assembly is configured to sense liquid drops passing through the channel; a carousel defining a plurality of housings each configured to hold a container; and a controller in electrical communication with the sensor assembly and the pinch valve assembly; wherein a fluid flow path is defined through the injection device, the column, the nozzle, the sensor assembly, and the carousel, wherein the controller is configured to move the carousel such that any one of the plurality of housings may be in the fluid flow path.

In certain embodiments, each of the column, the injection device, the nozzle, the pinch valve assembly, the sensor assembly, and the carousel is mounted on a support.

In certain embodiments, the pinch valve assembly comprises a pinch valve with an arm tip and a block, wherein the arm tip is configured to pinch the nozzle against the block. In particular embodiments, the block comprises a curved indent configured to receive the arm tip.

In certain embodiments, the sensor assembly is disposed in the fluid flow path between the nozzle and the carousel.

In certain embodiments, the sensor assembly is not within or a part of the carousel.

In certain embodiments, the controller is configured to move a gear or wheel which drives movement of the carousel.

In certain embodiments, the controller is configured to count liquid drops sensed by the sensor assembly.

In certain embodiments, the automatic fraction collector further comprises a pump in electrical communication with the controller and configured to actuate the injection device, wherein the controller is configured to control introduction of the fluid from the injection device into the column.

In certain embodiments, the controller is configured to rotate the carousel based on the counted liquid drops.

In certain embodiments, the controller is configured to control the pinch valve assembly so as to restrict liquid drops flowing through the nozzle based on information received by the controller from the sensor assembly.

In certain embodiments, the automatic fraction collector further comprises a cleaning buffer container configured to house a cleaning buffer, and a washing buffer container configured to house a washing buffer, wherein each of the first external container and the second external container is in fluid communication with the column through tubing that bypassese the injection device. In particular embodiments, the automatic fraction collector further comprises a cleaning buffer pump configured to pump the cleaning buffer from the cleaning buffer container into the column, and a washing buffer pump configured to pump the washing buffer from the washing buffer container into the column. In particular embodiments, each of the cleaning buffer pump and the washing buffer pump is in electrical communication with the controller, such that the controller is configured to control pumping of the washing buffer and the cleaning buffer into the column.

In certain embodiments, the automatic fraction collector further comprises a status indicator light in electrical communication with the controller.

Further provided is a method of detecting a drop from a size exclusion chromatography column, the method comprising introducing a fluid to a size exclusion chromatography column; allowing the fluid to pass through the size exclusion chromatography column, through a nozzle, and into a sensor assembly, the sensor assembly comprising a body defining a channel therethrough, an IR emitter on a first side of the channel, and an IR detector on an opposing second side of the channel; and sensing a drop passing through the channel by detecting an interruption of IR light between the IR emitter and the IR detector, thereby detecting the drop.

In certain embodiments, the method further comprises preventing flow through the nozzle with a pinch valve assembly.

In certain embodiments, the method further comprises controlling the introduction of fluid with a controller in electrical communication with the sensor assembly based on information received from the sensor assembly.

In certain embodiments, the method further comprises collecting the drops in a container disposed in a carousel. In particular embodiments, the method further comprises rotating the carousel automatically based on drops sensed by the sensor assembly.

In certain embodiments, the method further comprises injecting a cleaning buffer and/or a washing buffer into the size exclusion chromatography column automatically based on drops sensed by the sensor assembly.

Further provided is a method of separating exosomes from protein with the automatic fraction collector of claim 1, the method comprising injecting a fluid comprising a sample mixture of exosomes and protein into the column, wherein the column is a size exclusion chromatography column; allowing the sample mixture to separate in the column into exosome drops and protein drops; and collecting the exosome drops in a container held in one of the plurality of housings.

Further provided is a system comprising an apparatus comprising an injection device, a column, a nozzle, a sensor assembly, and a carousel in fluid communication; a pinch valve assembly capable of permitting and restricting fluid flow through the nozzle; and a controller in electrical communication with the injection device, the sensor assembly, the carousel, and the pinch valve assembly; wherein the controller is configured to receive information from the sensor assembly to detect and count drops passing through the sensor assembly, and take any of the following actions based on the received information: (i) move the carousel, (ii) inject sample from the injection device into the column, (iii) actuate the pinch valve assembly to restrict fluid flow through the nozzle, (iv) display the information on a graphical user interface, (v) illuminate a status indicator light, (vi) load a sample from a sample container into the injection device, (vii) load a washing buffer from a washing buffer container into the column, or (viii) load a cleaning buffer from a cleaning buffer container into the column.

In certain embodiments, the controller is configured to automatically sustain a flow of fluid by activating the injection device, moving the carousel, reloading the injection device, and using the sensor assembly to sense liquid drops flowing through a channel of the sensor assembly.

In certain embodiments, the system further comprises a second column.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

FIG. 1: View of an automatic fraction collector in accordance with the present disclosure.

FIGS. 2A-2B: Perspective views of a sensor assembly in accordance with the present disclosure, from the top in isolation (FIG. 2A) and from the side (FIG. 2B).

FIGS. 3A-3B: Views of a pinch valve assembly in accordance with the present disclosure, showing the valve closed (FIG. 3A) and showing the valve open (FIG. 3B).

FIG. 4: View of a carousel in accordance with the present disclosure.

FIG. 5: View of the front side of a support in accordance with the present disclosure, showing an indicator light, an injection device bracket, and an arm bracket.

FIG. 6: View of a controller in accordance with the present disclosure.

FIG. 7: Graph showing relative fluorescence units (RFUs) of DiO-exosomes and AF647-IgG at 470 nm and at 637 nm, showing an exosome peak at fractions 7 and 8, a protein peak at fractions 13-15, and a free DiO dye peak at fractions 16-18, demonstrating that stained exosomes were separated from protein and unstained free dye.

FIG. 8: Electron microscopy image showing an isolated exosome.

FIG. 9: Zetaview® image showing isolated exosomes.

FIG. 10: Graph showing isolated exosome particle size.

FIG. 11: Graph showing isolated exosome zeta potential.

### DETAILED DESCRIPTION

Throughout this disclosure, various publications, patents, and published patent specifications are referenced by an identifying citation. The disclosures of these publications, patents, and published patent specifications are hereby incorporated by reference into the present disclosure in their entirety to more fully describe the state of the art to which this invention pertains.

Provided herein is a device capable of fully automatic isolation and purification of exosomes or extracellular vesicles (EVs) based on SEC, and otherwise capable of fully automatic chromatography processes. The device is a robotic device that provides simple solutions for fast, precise, and automated isolation of exosomes and extracellular veiscles, which allow for high purity and reproducibility as well as a miximal yield of EV product. Advantageously, in some embodiments, the device can work from beginning to end with no intervening, making the process of isolating exosomes much easier and faster. The device is capable of fully automatically processing exosome purification and isolation by SEC regardless of sample volume and type. Advantageously, as describe in more detail below, the device can use the detection of liquid product drops to control everything, and does not need a weight sensor.

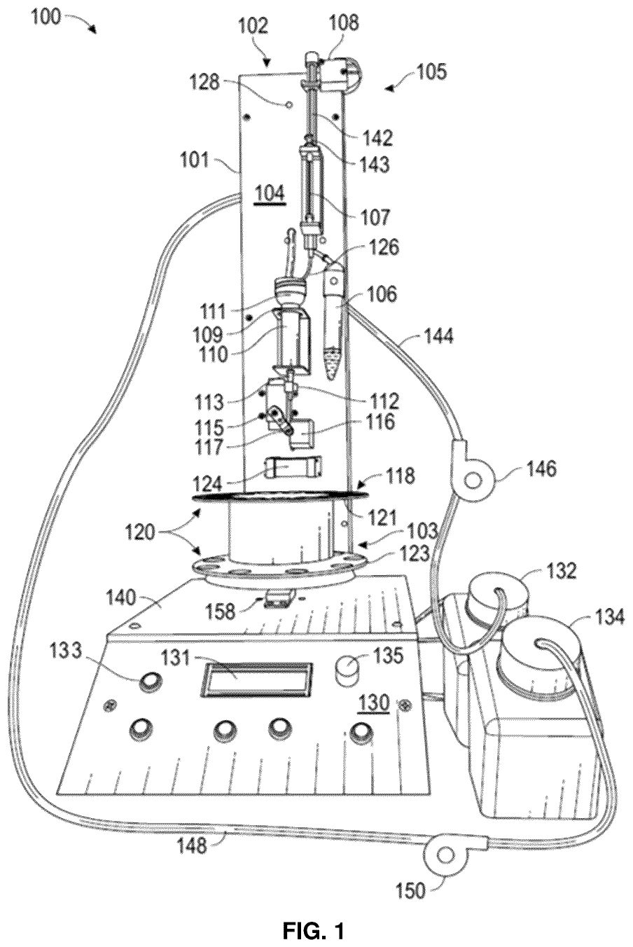

Referring now to FIG. 1, depicted is an automatic fraction collector 100 usable to collect a liquid having been run through a column 110. A fluid flow path running through the automatic fraction collector 100 is defined beginning with a sample container 106, through an injection device 107, into a column 110, into a nozzle 112, through a sensor assembly 124, and into a carousel 118. These enumerated elements or components along the fluid flow path are therefore in fluid communication, such as through flexible plastic tubing 126, piping, or any other conduit capable of conveying a fluid, and/or through gaps between aligned elements via the action of gravity. The fluid flow path may terminate in the carousel 118 or may alternatively continue past the carousel 118 into a desired container. Furthermore, a cleaning buffer or a washing buffer may be run through the column 110 as part of any process using the automatic fraction collector 100, and when this is done the fluid flow path may begin in a cleaning buffer container 132 or a washing buffer container 134 instead of the sample container 106, and the fluid flow path may bypass the injection device 107. Instead, fluid from the cleaning buffer container 132 and/or the washing buffer container 134 may be conveyed via an additional pump 146, 150 directly into the column 110 through a bypass tube 138 that bypasses the injection device 107.

Referring still to FIG. 1, the automatic fraction collector 100 may include a support 101. The support 101 acts as a frame or other structural support for various components of the automatic fraction collector 100. The support 101 can be an elongated piece of metal, or other rigid material, capable of securing various components of the automatic fraction collector 100 in place relative to each other. However, other materials and shapes are entirely possible and encompassed within the scope of the present disclosure. The support 101 extends from a first end 102 to a second end 103, and has one or more holes 156 therethrough configured to facilitate tubing 126, 138 running from the front side 104 of the support 101 to the back side 105 of the support 101. The automatic fraction collector 100 may be oriented such as that the first end 102 is vertically higher than the second end 103. Such an orientation is beneficial when conducting a size exclusion chromatography process because of the benefits of gravity. Such an orientation is also beneficial for allowing gravity to transfer fluid between various components of the automatic fraction collector 100 in the fluid flow path. However, a vertical orientation is not necessary. For example, it should be recognized that fluids can be forced through the column 110 without the aid of gravity, such as by the use of pumps. Therefore, other relative orientations of the first end 102 and the second end 103 are possible and encompassed within the scope of the present disclosure. Moreover, it is possible for the automatic fraction collector 100 to not include a support 101 at all, for example by using pumps, and such embodiments are encompassed within the scope of the present disclosure.

Referring still to FIG. 1, the support 101 includes a front side 104 and a back side 105. The terms “front” and “back” are used for convenience, merely to illustrate that various components of the automatic fraction collector 100 can be secured to the same side of the support 101. However, it should be understood that through the use of tubing, it is not strictly necessary for any two components of the automatic fraction collector 100 to be disposed on the same side of the support 101. Furthermore, as noted above, it is not even necessary for the automatic fraction collector to include a support 101 at all. Instead, the various components along the fluid flow path can be connected through tubing without being mounted to anything or held in place relative to each other. When a support 101 is used, the second end 103 may be secured to a base 140, which can be used to house a controller 130 configured to run the automatic fraction collector 100 as described in more detail below.

Referring still to FIG. 1, the injection device 107 may be mounted on the front side 104 of the support 101. The injection device 107 is capable of holding a volume of a fluid. In some embodiments, the injection device 107 can hold about 500 microliters of a liquid. In one non-limiting example, the injection device 107 is a syringe, such as a 1 ml syringe. The sample container 106 may also be mounted on the front side 104 of the support 101, and is in fluid communication with the injection device 107. A pump 108 may be configured to actuate the injection device 107 so as to draw fluid out of the sample container 106 and into the injection device 107, or alternatively pump fluid from the sample container 106 into the injection device 107 through tubing 126. The pump 108 may be driven by a stepper motor. However, other pumps are possible and encompassed within the scope of the present disclosure. The pump 108 can then further actuate the injection device 107 so as to push the fluid out of the injection device and into the column 110. For example, when the injection device 107 is a syringe, the pump 108 may include an arm 142 configured to push and pull the plunger 143 of the syringe. The pump 108 is in electrical communication with the controller 130 such that the controller 130 is configured to control the actions of the pump 108.

Referring still to FIG. 1, the column 110 may be mounted on the front side 104 of the support 101 and is in fluid communication with the injection device 107 such that fluid pushed out of the injection device 107 by the pump 108 enters the column 110 at a column entrance 111. The column entrance 111 may optionally include a funnel or other structural feature configured to house liquid waiting to run through the column 110. For example, when fluid flow through the nozzle 112 is restricted, the flow of fluid through the automatic fraction collector 100 may back up such that fluid collects in the column entrance 111. Thus, the column entrance 111 is configured to hold a volume of fluid, such as 500 microliters of fluid. In some embodiments, the column entrance 111 has a large enough volume to accommodate all of the fluid injected by the injection device 107. Therefore, in some embodiments, the column entrance 111 can house at least the same volume of liquid as the injection device 107. Fluid in the column entrance 111 may fall into the column 110 by gravity when the column 110 is not saturated with fluid.

Referring still to FIG. 1, the column 110 may be any structure capable of holding a stationary phase and allowing a mobile phase to pass through it. The column 110 may be, for example, a size exclusion chromatography (SEC) column, or other chromatography column. The column 110 can be an off-the-shelf commercially available SEC column. The column 100 may be, for example, a 2 ml column, a 5 ml column, or a 10 ml column. However, other sizes of columns 110 are possible and encompassed within the scope of the present disclosure. The column 110 may be mounted to the support 101 with a bracket 109, where the bracket 109 is fastened to the front side 104 of the support 101 and the column 110 is disposed within, and removable from, the bracket 109.

Alternatively, the column 110 may actually be a plurality of columns 110, which allows for more sample to be run through the automatic fraction collector 100 simultaneously. The plurality of columns 110 may be loaded with identical stationary phases or different stationary phases. If a plurality of columns 110 is present, then a plurality of brackets 109 may be used to attach the columns 110 to the support 101. Alternatively, the plurality of columns 110 may be movable within a single bracket 109. Similarly, the automatic fraction collector 100 may include a plurality of injection devices 107, a plurality of nozzles 112, a plurality of sensor assemblies 124, and/or a plurality of carousels 118. In any such embodiments, the injection device 106, column 110, nozzle 112, sensor assembly 124, and carousel 118, or plurality of any of said components, may be independently movable or stationary on the support 101.

Referring again to FIG. 1, fluid exits the column 110 through a column exit 113 which may be directly connected to the nozzle 112 or may alternatively be aligned with the nozzle 112 with a gap therebetween such that fluid exiting the column exit 113 falls into the nozzle 112 by action of gravity. The nozzle 112 is a section of tubing or piping that serves to provide a location downstream of the column 110 where fluid flow can be permitted or prevented on command, as described in more detail below, as well as direct the fluid flow into the sensor assembly 124 either by gravity or affirmative connection such as tubing or piping. The nozzle 112 is therefore flexible or malleable enough that the nozzle 112 can be pinched or squeezed so as to restrict fluid flow through the nozzle 112. The nozzle 112 may be tapered so as to accommodate a variety of sizes of column 110 or column exit 113. The nozzle 112 may be purchased commercially, such as from IZON science (MA, USA). The nozzle 112 extends through the pinch valve assembly 114 (e.g., between an arm tip 117 and a block 116 of the pinch valve assembly 114) to accommodate being pinched by the pinch valve assembly 114.

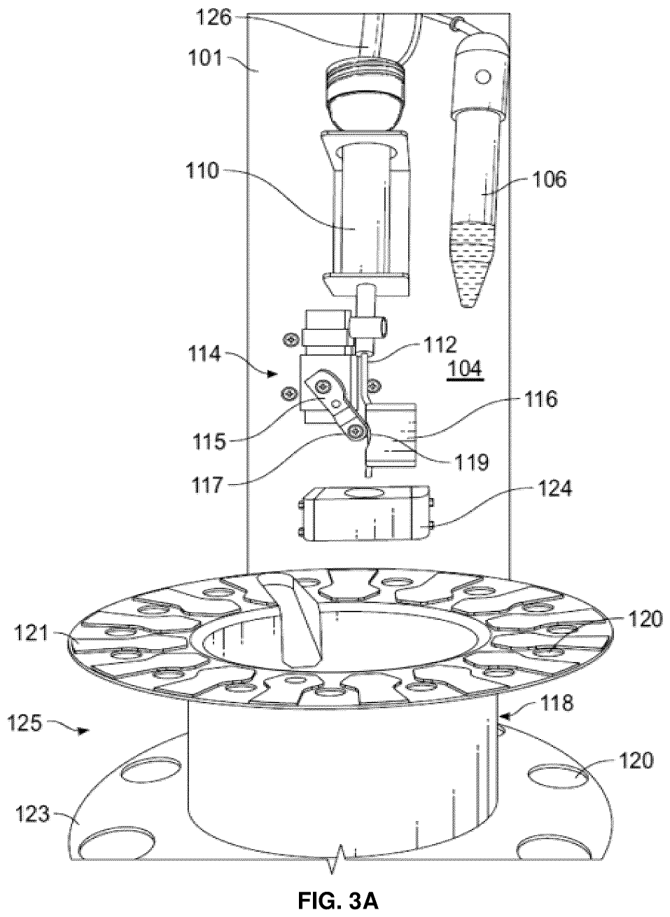

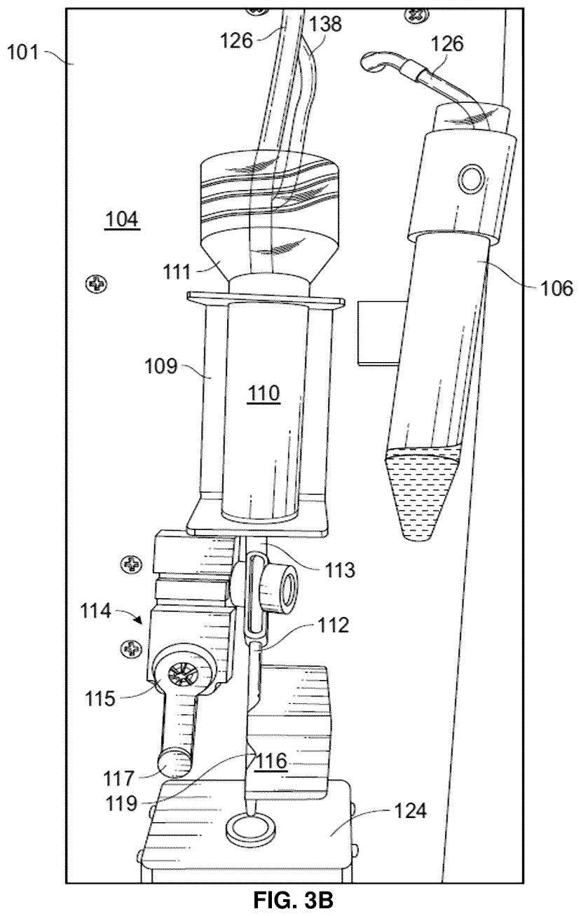

Referring to FIG. 1 and FIGS. 3A-3B, a pinch valve assembly 114 may be mounted to the front side 104 of the support 101. The pinch valve assembly 114 is configured to prevent or restrict fluid flow through the nozzle 112 on command. The pinch valve assembly 114 is therefore in electrical communication with the controller 130, which may run a program that involves pinching the nozzle 112 with the pinch valve assembly 114 at various points, and for various time durations, during an automated process. The pinch valve assembly 114 may include a pinch valve 115 and a block 116. The block 116 can be any solid structure that serves as a backing against which the pinch valve 115 can pinch the nozzle 112, and may be made of, for example, plastic, wood, metal, glass, Styrofoam, or ceramic. The pinch valve 115 may include, but is not limited to, a rotational pinch valve with an arm tip 117 that pressures the nozzle 112 into the block 116 with sufficient pressure to restrict or terminate fluid flow through the nozzle 112. The block 116 may include a curved indent 119 configured to receive the pinch valve arm tip 117. Advantageously, the curved indent 119 accommodates the somewhat rotational motion of the arm tip 117 and allows for a fuller pinching of the nozzle 112. The pinch valve assembly 112 accomplishes a restriction of fluid flow through the nozzle 112 by physically pinching the nozzle 112 against the block 116 so as to occlude flow of fluid through the nozzle 112, as shown in FIG. 3A. In an alternative embodiment, the pinch valve assembly 114 may include two pinch valves 115 which cooperate to pinch the nozzle 112 between them and thereby restrict or terminate fluid flow through the nozzle 112.

In some embodiments, the pinch valve assembly 114 is a solenoid pinch valve. In other embodiments, the pinch valve assembly 114 is a servo pinch valve assembly. Unlike a solenoid or electromagnetic valve, using a servo to control liquid flow does not produce heat when there is a long holding time open or close. A servo also has more power than a solenoid. A servo-driven pinch valve assembly 114 can control the liquid flow from the column 110 with precision. In some embodiments, the pinch valve assembly 114 is not an electromagnetic force-controlled pinch valve. Electromagnetic force-controlled pinch valves cause tubing to stick after long holding periods due to the heat produced from the electromagnetic holding.

When the nozzle 112 is not occluded by the pinch valve assembly 114 (i.e., when the pinch valve assembly 114 is ‘open’, as shown in FIG. 3B), fluid may flow through the nozzle 112 into the sensor assembly 124. Accordingly, the nozzle 112 is in fluid communication with the sensor assembly 124. It is understood, however, that this fluid communication may include a gap (i.e., an absence or tubing or piping) through which the fluid falls by the action of gravity into the sensor assembly 124. The sensor assembly may also be mounted to the front side 104 of the support 101.

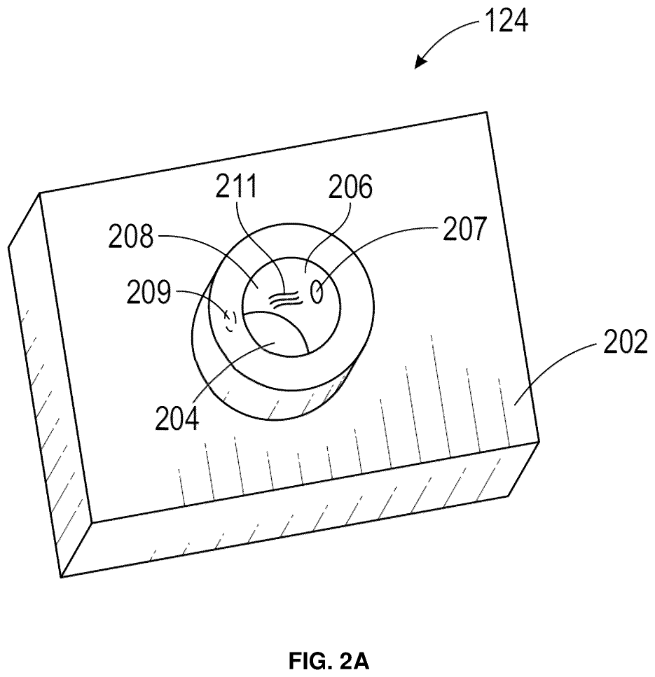

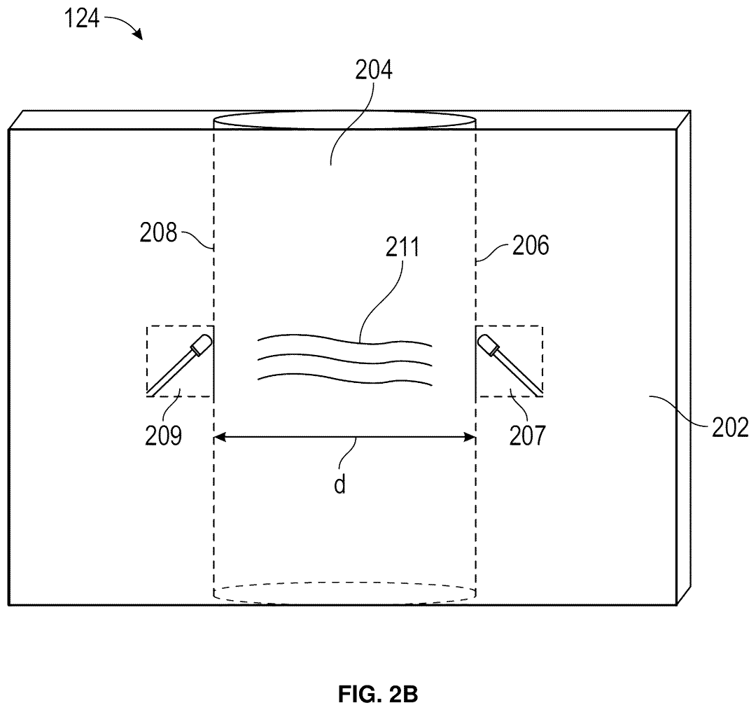

Referring now to FIGS. 2A-2B, the sensor assembly 124 includes a body 202 and a channel 204 therethrough. The body 202 can be made from any solid material, such as metal, foam, wood, plastic, or ceramic. The channel 204 can have an interior surface with an annular shape. That is, the channel 204 may have a circular cross-section. However, other shapes of the channel 204 are possible and encompassed within the scope of the present disclosure. The channel 204 has a diameter d that is at least large enough to allow drops of a liquid to pass through the channel 204. The interior surface can have a first side 206 and an opposing second side 208. An IR emitter 207 is disposed in the body 202 on the first side 206 so as to be configured to emit IR light traveling across the channel 204 to the opposing second side 208. The IR emitter 207 can be, for example, an LED infrared emitter. An IR detector 209 is disposed in the body 202 on the opposing second side 208 so as to be configured to detect the IR light emitted from the IR emitter 207 after the IR light has travelled through the channel 204. The IR detector 209 can be, for example, an IR receiver diode. In alternative embodiments, the IR detector 209 can be replaced by a laser sensor, provided the laser sensor is capable of detecting the IR light 211 emitted by the IR emitter 207 after the IR light 211 has travelled through the channel 204. The IR emitter 207 and the IR detector 209 are each in electrical communication with the controller 130, such that the controller 130 is configured to control the emission of IR light 211 by the IR emitter 207 and receive information about the detection of the IR light from 211 the IR detector 209.

Referring to FIGS. 2A-2B, liquid drops flowing out of the nozzle 112 and into the sensor assembly 124 are directed into the channel 204 either by tubing or simply by alignment and gravity. The liquid drops then travel through the channel 204, such as, but not limited to, by the force of gravity. As the liquid drops travel through the channel 204, the liquid drops interrupt and temporarily block (by absorption or scattering) the IR light 211 from travelling through the channel 204 such that the IR detector 209 is unable to detect the IR light 211 when a drop of liquid is in the channel 204 between the IR emitter 207 and the IR detector 209. In this manner, the sensor assembly 124, by virtue of the IR emitter 207 and the IR detector 209 being in electrical communication with each other, is able to determine when a drop of liquid is present in the channel 204 (i.e., when the transmission of IR light 211 is interrupted and prevented from reaching the IR detector 209) and when no drop of liquid is present in the channel (i.e., when the IR light 211 from the IR emitter 207 reaches the IR detector 209 because the transmission of the IR light 211 through the channel 204 is not interrupted by the present of a drop of liquid in the channel 204). In other words, the sensor assembly 124 can determine whether the transmission of IR light 211 is interrupted, and therefore a drop of liquid is present in the channel 204, or not. The sensor assembly 124 can communicate with the controller 130 that the sensor assembly 124 detects or does not detect the IR light 211, and therefore that the sensor assembly 124 detects or does not detect the presence of liquid in the channel 204. Thus, the sensor assembly 124 can communicate to the controller 130 whenever the sensor assembly 124 detects a liquid drop passing through the sensor assembly 124. The controller 130, in turn, can count the drops detected, and control a variety of actions such as the injection of sample fluid into the column 110 based on the number or rate of drops detected according to a pre-defined algorithm or program. Thus, the sensor assembly 124 serves to monitor and count liquid drops, which can be used for calculation of volume of fractions and determining the timepoints for loading samples, washing buffer, and cleaning buffer.

The use of infrared light in the sensor assembly 124 to detector and count liquid drops in order to control the system is highly advantageous. The sensor assembly 124 overcomes the shortage of other sensors that are frequently influenced by daylight, because the sensor assembly 124 utilizes infrared light instead of visible light. The sensor assembly 124 is also sensitive and accurate. However, it is understood that any wavelength of light can be used in the sensor assembly 124, and such embodiments are encompassed within the scope of the present disclosure. Regardless of the wavelength of light being detected in the sensor assembly 124, the sensor assembly 124 eliminates the need to include a weight sensor in the automatic fraction collector 100. Therefore, in some embodiments, the automatic fraction collector 100 does not include a weight sensor.

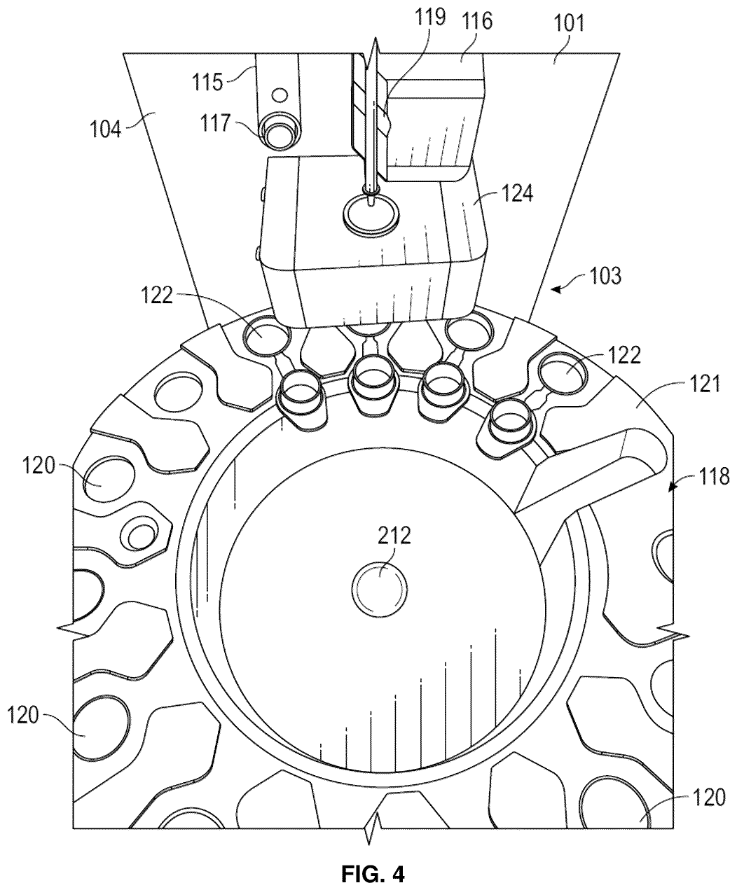

Referring now to FIGS. 1, 4, a carousel 118 is disposed in fluid communication with the sensor assembly 124. More specifically, a fluid, such as liquid drops, may pass through the channel 204 of the sensor assembly 124 and then travel into one of a plurality of housings 120 within the carousel 118. The fluid communication between the sensor assembly 124 and the carousel 118 may be by a gap and the action of gravity, such that drops passing through the channel 204 simply fall into the carousel 118. However, other configurations and connections (such as through tubing) are possible and encompassed within the scope of the present disclosure. The housings 120 are each configured to received, and hold, a container 122 for collecting liquid product. The containers 122 may be, for example, test tubes or scalable containers with lids.

Referring still to FIGS. 1, 4, the carousel 118 may be accommodated on the first side 104 of the support 101 at the second end 103. The carousel 118 can have a shape similar to that of a spool or reel. However, other shapes are possible and encompassed within the scope of the present disclosure. The carousel 118 may be a rotatable, slidable, or otherwise movable member that defines a plurality of housing 120 therein. Each of the plurality of housings 120 may be formed within a top plate 121 and a bottom plate 123 with a gap 125 therebetween, where a container 122 can be disposed within the housing 120 and secured therein by resting on the bottom plate 123 and/or being held by or within the top plate 121. The carousel 118 is capable of rotating, sliding, or otherwise moving such that any one of the plurality of housings 120 may be in fluid communication with the sensor assembly 124 (i.e., any one of the plurality of housings 120 may be in the fluid flow path). The carousel 118 can be made from any solid material, such as, but not limited to, plastic, wood, metal, glass, Styrofoam, or ceramic. The fluid flow path may terminate in any one of the plurality of housings 120, as each of the plurality of housings 120 is configured to hold a container 122 for collecting liquid product. In one embodiment, the housings 120 are shaped in a circle or otherwise configured to receive a container 122. However, the housings 120 can be placed in any configuration in the carousel 118 and can have any shape.

In some embodiments, the carousel 118 is a rotatable member configured to dispose any one of the plurality of housings 120 directly underneath the channel 204 of the sensor assembly 124 such that the action of gravity causes liquid drops passing through the channel 204 to fall into the particular housing 120 disposed underneath the channel 204. In this way, when a container 122 is disposed in the particular housing 120 disposed underneath the channel 204, the container 122 catches the drops that fall from the sensor assembly 124. The carousel 118 may be purchased commercially, such as from IZON science (MA, USA).

Referring to FIG. 1, the carousel 118 is in electrical communication with the controller 130 such that the controller 130 is capable of rotating, sliding, or otherwise moving the carousel 118 so as to change which of the plurality of housings 120 is disposed underneath, or otherwise in fluid communication with, the sensor assembly 124. Alternatively, the carousel 118 is mounted on a wheel or gear 158 which is controlled by the controller 130 such that the controller 130 may move the carousel 118 by moving the wheel or gear 158. For instance, referring now to FIGS. 1, 4, the carousel 118 may include a central nut 212 that interacts with a spinning gear 158 protruding from the base 140 and controlled by the controller 130. A servo can drive rotations of the carousel 118 to collect liquid product fractions. Alternatively, a stepper motor can be used to drive rotations of the carousel 118. However, many other methods and structures for causing movement of the carousel 118 are possible and encompassed within the scope of the present disclosure. Accordingly, the controller 130 can receive information from the sensor assembly 124 regarding the number or rate of liquid drops passing through the sensor assembly 124, and use this information to control when to rotate, slide, or otherwise move the carousel 118 to place a different one of the plurality of housings 120 in the fluid flow path. This allows for the container 122 to be filled to a desired volume without overflowing before a different container 122 is utilized to collect product.

Referring still to FIGS. 1, 4, the carousel 118 can have any configuration and number of housings 120. In one example embodiment the housings 120 and containers 122 are defined in a circular arrangement around the carousel 118. In another example embodiment, the housings 120 are defined in a linear arrangement, and instead of the carousel 118 rotating to switch between containers 122, the carousel 118 can be moved left and right or back and forth along the linear arrangement. Any one of the housings 120 can be put into the fluid flow path. However, a housing 120 does not have to have a container 122. Rather, a housing 120 may be left empty to allow liquid to flow through the carousel 118 if desired.

The controller 130 may execute a program which does not move the carousel 118, or a program which moves the carousel 118 at various times, and for various durations, during an automated process. The movement of the carousel 118 may be in accordance with a set number of liquid drops detected by the sensor assembly 124 and communicated to the controller 130. Advantageously, the carousel 118 can be automatically moved to fill multiple containers 122 without the column 110 or nozzle 112 having to be moved.

Referring still to FIG. 1, the carousel 118 is disposed on the base 140, and may rotate around an axis that is orthogonal to the base 140. In other embodiments, the carousel 118 may be an elongated member that slides along a track to change containers 122 disposed in the fluid flow path. In still other embodiments, the carousel 118 may be but one carousel disposed in a carousel receptacle. Having multiple carousels 118 increases the number of containers 122 that can be used, and thereby effectively increases the amount of liquid that can be collected in containers 122.

In alternative embodiments, the carousel 118 may be used to allow liquid drops exiting the sensor assembly 124 to pass entirely through the carousel 118. This may be useful if, for example, a waste container or waste tubing is disposed underneath the carousel 118 to catch liquid drops other than desired product. Thus, the carousel 118 is not required to be at the end of the fluid flow path. Rather, the carousel 118 may have paths free for liquid drops to pass through the carousel 118.

The controller 130 may cause the pinch valve assembly 114 to restrict flow through the nozzle 112 while the carousel 118 is moved so as to ensure that no drops of liquid product are directed to, or otherwise enter, an undesired area of the carousel 118. For example, liquid product will not fall to a space in the carousel 118 between containers 122 because its flow through the fluid flow path will be stopped at the nozzle 112 while the carousel 118 is moved to switch containers 122 aligned in the fluid flow path.

Advantageously, because the sensor assembly 124 is not included in the carousel 118, the carousel 118 is easily switched out or replaced as needed. Because the mode of detection of the liquid drops is upstream in the fluid flow path of the carousel 118, the carousel 118 does not need to include a weight sensor or any other type of sensor. This makes the carousel 118 more easily changed or customized for a desired application.

Referring now to FIG. 1, the automatic fraction collector 100 may include a cleaning buffer container 132. The cleaning buffer container 132 is configured to house a volume of a suitable cleaning buffer such as, but not limited to: water, ethanol, NaOH, detergents, or combinations thereof. The cleaning buffer container 132 is in fluid communication with the column 110 through tubing 144, 138 that bypasses the injection device 107. A cleaning buffer pump 146 is configured to pump cleaning buffer from the cleaning buffer container 132 and into the column 110 through cleaning buffer tubing 144 that bypasses the injection device 107. The cleaning buffer pump 146 is in electrical communication with the controller 130, such that the controller 130 is configured to control when, how much, and for how long or how many rotations cleaning buffer is pumped into the column 110.

Referring again to FIG. 1, the automatic fraction collector 100 may include a washing buffer container 134. The washing buffer container 134 is configured to house a volume of a suitable washing buffer such as, but not limited: phosphate buffers such as phosphate-buffered saline (PBS) or sodium phosphate, sodium chloride, acetic acid, pyridine, ammonia, combinations thereof, or any other solution which resists changes in pH, including but not limited to such solutions having a pH between about 6.0 and about 8.0. It is understood that the identity of the washing buffer may be selected based on its pH and composition being within the range of the application of the particular column 110 being used, and the solubility in the washing buffer of the particular sample to be run through the column 110. The washing buffer container 134 is in fluid communication with the column 110 through washing buffer tubing 148 that bypasses the injection device 107. A washing buffer pump 150 is configured to pump washing buffer from the washing buffer container 134 and into the column 110 through washing buffer tubing 148, 138 that bypasses the injection device 107. The washing buffer pump 150 is in electrical communication with the controller 130, such that the controller 130 is configured to control when, how much, and for how long or how many rotations washing buffer is pumped into the column 110.

Optionally, the cleaning buffer pump 146 and the washing buffer pump 150 may be the same, single pump. Utilizing a single pump to pump cleaning buffer from the cleaning buffer container 132 and washing buffer from the washing buffer container 134 into the column 110 saves space and power. The controller 130 may automatically change the liquid feeding into the column 110 as between fluid from the sample container 106, the washing buffer container 134, and the cleaning buffer container 132 according to a pre-set program or according to information received from the sensor assembly 124.

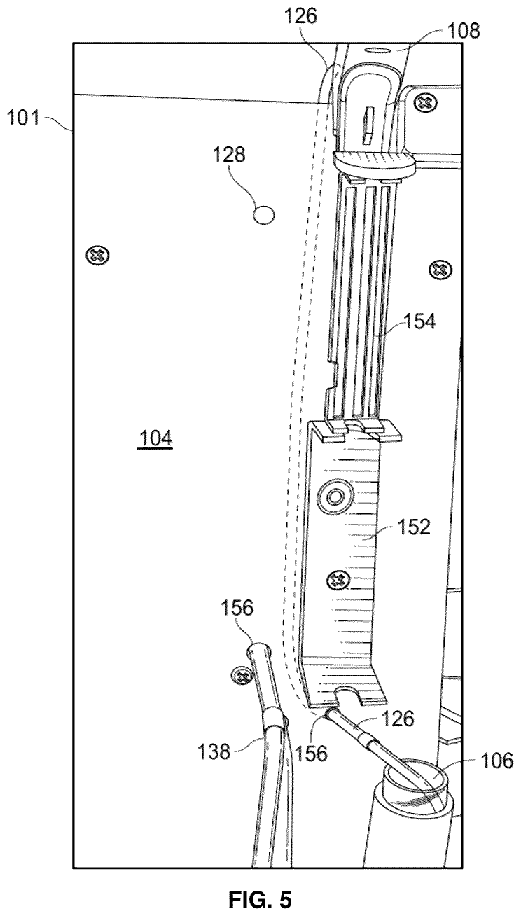

Referring now to FIG. 5, the support 101 may include an indicator light 128. The indicator light 128 may be any suitable LED or other light in electrical communication with the controller 130. The controller 130 is configured to illuminate the indicator light 128 when, for example, a program is in operation. A user may program the indicator light 128 to illuminate at any desired time for convenience of the user. As also seen in FIG. 5, the support 101 may include an injection device bracket 152 configured to hold the injection device 107. FIG. 5 depicts the injection device bracket 152 without an injection device 107. Conveniently, the injection device bracket 152 allows for the injection device 107 to be easily switched out or removed for cleaning or other maintenance. The injection device bracket 152 may be any rigid framing member configured to hold a syringe or other injection device 107. Once inserted into the injection device bracket 152, the injection device 107 can be made to be in fluid communication with the column 110 by connecting the injection device 107 to tubing 126.

Referring still to FIG. 5, the support 101 may include an arm bracket 154 configured to hold the arm 142 of the pump 108 in a position where the arm 142 may actuate a plunger 143 of the injection device 107. FIG. 5 shows the arm bracket 154 without the arm 142. Advantageously, the arm bracket 154 allows for different arms 142 or pumps 108 to be utilized in connection with different injection devices 107, and allows for easy removal of the arm 142 and pump 108 for cleaning or other maintenance.

Referring still to FIG. 5, it can be seen that the tubing 126 connecting the sample container 106 to the pump 108 can be run along the back side 105 of the support 101 so as to minimize the amount of tubing 126 on the front side of the support 101. The tubing 126 can cross through the support 101 through a hole 156 in the support 101 to run along the back side 105 of the support 101 up to the pump 108 which may pump liquid sample from the sample container 106 into the injection device 107.

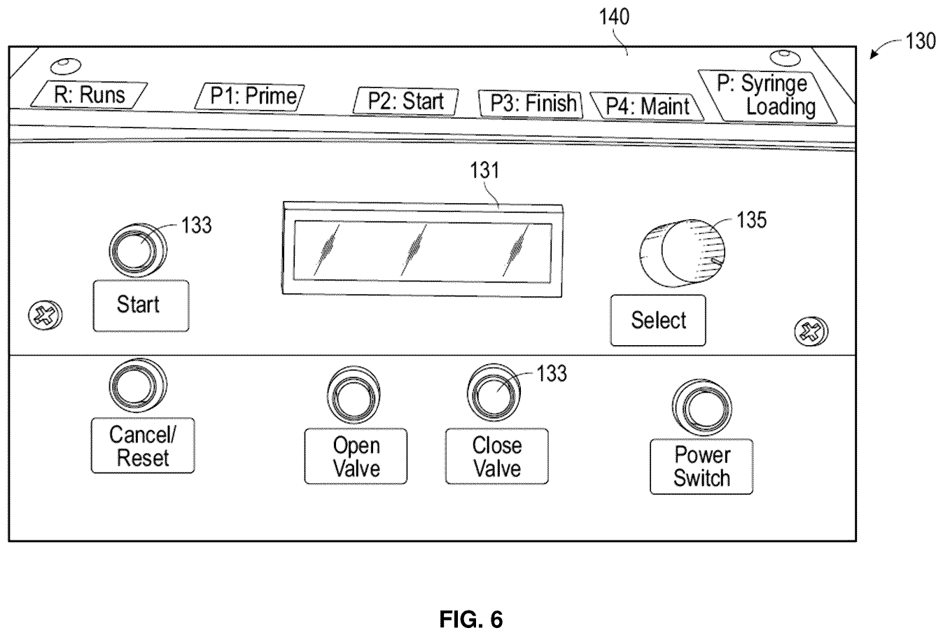

Referring now to FIG. 6, the controller 130 can be any suitable computing device capable of executing the functions as described herein according to a programmable code. The controller 130 may be housed within the base 140. In some embodiments, the automatic fraction collector 100 is controlled with an Arduino Mega 2560 microcontroller and a well-written program that drives the system running smoothly and efficiently. The controller 130 may utilize a single chip, or may alternatively include a chip, board, and suitable wiring. The controller 130 may include a graphical user interface or other display 131, along with buttons 133 convenient user interfacing and one or more control knobs 135 for selecting pre-set programs. The plurality of buttons 133 can be configured to operate the automatic fraction collector 100. The plurality of buttons 133 can be assigned a variety of functions including, but not limited to, opening the pinch valve assembly 114; closing the pinch valve assembly 114; starting the automatic fraction collector 100; canceling and/or resetting the automatic fraction collector 100; and powering on the the automatic fraction controller 100. The controller is configured to receive information from the sensor assembly 124 relating to the detection and sensing of liquid drops in the sensor assembly 124, and take any or all of the following actions either independently or based on the information received from the sensor assembly 124: move the carousel 118, inject sample from the injection device 107 into the column 110, actuate the pinch valve assembly 114 to restrict fluid flow through the nozzle 112, display information on the graphical user interface 131, illuminate a status indicator light (such as the light 128 on the support 101 depicted in FIG. 5), load a sample from the sample container into the injection device 107, load washing buffer into the column 110, or load cleaning buffer into the column 110. The user can program the controller 130 to take any or all of these actions in any sequence desired, and in response to any particular information received from the sensor assembly 124.

Referring still to FIG. 6, the graphical user interface or other display 131 may be a LCD display screen used to display the parameters and control selections. A rotary encoder can serve as functional selections.

Referring again to FIG. 1, the controller 130 may automatically change the liquid feeding into the column 110. Built-in programs may be used to run different orders of the pumps 108, 146, 150 in set orders or due to certain feedback received by the controller 130. For instance, samples, washing buffer, and cleaning buffer may be injected into the fluid flow path from feedback that the controller 130 receives from the sensor assembly 124 monitoring and counting liquid drops passing therethrough, which can be used for calculation of volume. In one embodiment, the controller 130 may automatically control the injection device 107 feeding a sample into the column 110, followed by controlling the washing buffer pump 150 feeding a washing buffer into the column 110 from the washing buffer container 134, followed finally by the cleaning buffer pump 146 feeding a cleaning buffer into the column 110 from the cleaning buffer container 132. This order or any other order can be repeated, reversed, or otherwise altered. The controller 130 may know the amount of cleaning buffer available in the cleaning buffer container 132, and the amount of washing buffer available in the washing buffer container 134, as these amounts may be pre-set in the program run by the controller 130. The controller 130 may also know the amount of cleaning buffer or washing buffer needed at any given time during operation, as these amounts may also be pre-set in the program run by the controller 130.

Drop counts detected by the sensor assembly 124 can be monitored by the controller 130 to control the whole system, including washing volume, loading time, fractioning timing, and fraction volume. The controller 130 can control washing, cleaning, sample loading, and fraction collection. The system can use exact amounts of buffer to wash the column, which is important to get rid of residual particles. The system can set perfect timing for loading samples automatically, which enables size separation efficiently and precisely. The system can also collect proper fractions and fraction amounts that ensure exosome products (or other desired products) in high purity and high yield. The program can ensure proper timing of sample loading, which is very important to obtain an efficient separation of exosome from protein.

Referring now to FIGS. 1-6, a non-limiting example method for using the automatic fraction collector 100 may begin by introducing a sample mixture into the sample container 106. In a method for separating exosomes from protein, the sample mixture may be a liquid mixture of exosomes and protein. The user may then set the controller 130 to run a pre-set program based on a number of options such as the number of fractions to be collected and the flow rate of sample into the column 110. The controller 130 may then cause the pump 108 to draw a specific volume of sample mixture from the sample container 106 into the injection device 107. The controller 130 may then actuate the injection device 107 with the arm 142 so as to cause sample mixture from inside the injection device 107 to be introduced into the column 110. The sample mixture is then allowed to run through the column 110. The duration of time that the sample mixture resides within the column 110 will depend on various factors such as the composition of the sample mixture, the particular stationary phase present in the column 110, and the size of the column 110. The column 110 may be a size exclusion chromatography column configured to separate exosomes from protein. Accordingly, liquid drops exit the column 110 at different times based on their composition. The liquid drops exit the column 110 and flow into the nozzle 112, where they are either allowed to pass into the sensor assembly 124 or stopped in the nozzle 112 by the pinch valve assembly 114. The controller 130 may allow a specific number of drops of the liquid to pass through the sensor assembly 124 before actuating the pinch valve assembly 114 to pause the flow of the drops through the nozzle 112. The drops that are allowed to pass into the sensor assembly 124 are counted by the sensor assembly 124 based on their passage through, and absorption or scattering of, the IR light 211 in the channel 204. The sensor assembly 124 conveys this count to the controller 130, which then causes the pinch valve assembly 114 to restrict flow through the nozzle 110 once the pre-set number of drops has been reached. The drops which pass through the sensor assembly 124 are collected in containers 112 in the housings 120 of the carousel 118.

After a pre-set number of drops have passed through the sensor assembly 124, the controller 130 rotates the carousel 118 so as to switch the container 122 in the fluid flow path to receive the drops. In this manner, the containers 122 do not overflow. Once all of the containers 122 have reached their pre-set capacity, the controller 130 can stop the flow of drops by actuating the pinch valve assembly 114 to restrict flow through the nozzle 112. The drops that are collected in the containers 122 have different compositions determined by how quickly they passed through the column 110. Thus, as time goes on during the process, the composition of the drops being received in the containers 122 changes to include different specific components present in the original sample mixture, and to not include different specific components present in the original sample mixture. If it is known to the user which drops include the desired exosome products, based on how long the exosomes take to pass through the specific column 110 being used, then the controller 130 may be programmed to collect the drops which include exosomes in the containers 122 but not collect the drops which do not include exosomes. Alternatively, the controller 130 can be programmed to collect the drops which contain exosomes in a first container 122 or first group of containers 122, but to collect the drops which do not contain exosomes in a second container 122 or second group of containers 122. In any case, the automatic fraction collector 100 can be washed and cleaned by utilizing the pumps 146, 150 to introduce washing buffer from the washing buffer container 134 and cleaning buffer from the cleaning buffer container 132 into the column 110. The washing buffer and/or the cleaning buffer may be allowed to pass through the nozzle 112 and sensor assembly 124 and collected in a container 122 designated as waste or for recycling of the buffer(s). Alternatively, the washing buffer and/or the cleaning buffer may be allowed to flow through, or otherwise past, the carousel 118 into a desired downstream apparatus or container. The cleaning buffer and the washing buffer may be used to clean the column 110 by removing any remaining sample from within the column 110. For example, the system can run automatic cleaning steps with the cleaning buffer and the washing buffer after finishing exosome (EV) isolation.

Advantageously, the automatic fraction collector 100 may be run to collect isolated exosomes in an entirely automated way using the controller 130. However, the automatic fraction collector 100 can be used entirely manually (i.e., without the controller 130), and such use is encompassed within the scope of the present disclosure. For example, a user may manually force the sample mixture liquid into the injection device 107, for example by drawing the plunger 143 of a syringe acting as the injection device 107 so as to draw liquid sample mixture into the syringe. A user may then manually inject the sample mixture into the column 110, for example by actuating the plunger of the syringe to inject the sample mixture into the column 110. In a manual use mode, the pinch valve assembly 114 and the sensor assembly 124 need not be used, and the product drops can be allowed to flow through the nozzle 112, through the sensor assembly 124, and directly into one or more containers 122 in the housing 120 until a desired volume of product is obtained, at which point the container 122 may be switched for another container 122.

Similarly, if the sample volume is more than 500 microliters, the automatic fraction collector 100 can be set to conduct multiple runs in order to finish the isolation automatically. A sample that has a volume which exceeds 500 microliters may need multiple runs through the automatic fraction collector 100. In such as scenario, some or all of the fractions collected in the carousel 118 may be reintroduced into the sample container 106, drawn back into the injection device 107 by the pump 108, and then injected back into the column 110 by the injection device 107. The reintroduction of the collected fractions into the sample container 106 can be done manually. Alternatively, suitable tubing with an additional pump may be set up to automatically convey some or all of the fractions collected in the carousel 118 back into the sample container 106, under the control of the controller 130 which repeats the process according to a program and based on the number of drops detected by the sensor assembly 124. In other words, once a certain number of drops has been reached, the program can recognize that the sample has been run through the column 110 the desired number of times, and the controller 130 will then cease reintroducing collected fractions into the sample container 106.

The automatic fraction collector 100 is particularly useful for isolating exosomes, and can run a fully automatic process of exosome isolation. Advantageously, the automatic fraction collector 100 is easy to learn and use. After a few minutes of training, a user can run the system easily. The system can be programmed for IMAC purification of proteins, or many other purposes, and can run automatic cleaning steps after finishing the exosome (EV) isolation. The system can have any number of pre-set programs, and as few as 15 pre-set programs may meet most needs in the field. However, the automatic fraction collector 100 is not limited to use for isolating exosomes.

Unlike other automatic fraction collector devices which require manually adding washing buffer or loading sample, or standing by the machine to push buttons in order to process each step, the automatic fraction collector herein requires no manual operation once a program is selected. This enhances accuracy, reduces the chances for errors or spills, eliminates tedious manual tasks, and makes the process more efficient. Furthermore, unlike other automatic fraction collectors which use collection based on weight, and therefore require calibration before each experiment, the automatic fraction collector herein senses drops using light and therefore does not require weight calibration. This results in both a time savings and a cost savings.

The skilled person will recognize that various electronic components such as L298 motor drivers, A4988 stepper motor drivers, diodes, triodes, resistors, capacitors, and a 12-volt power adaptor, can be employed in the automatic fraction collector 100. However, the automatic fraction collector 100 can be assembled using a variety of different parts all within the scope of the present disclosure.

### Examples

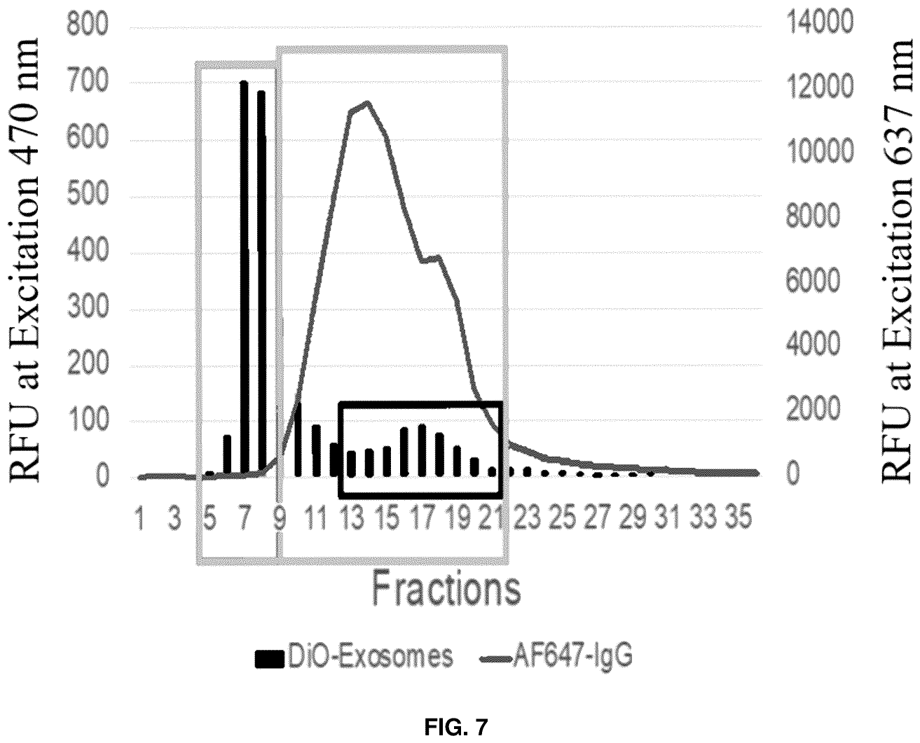

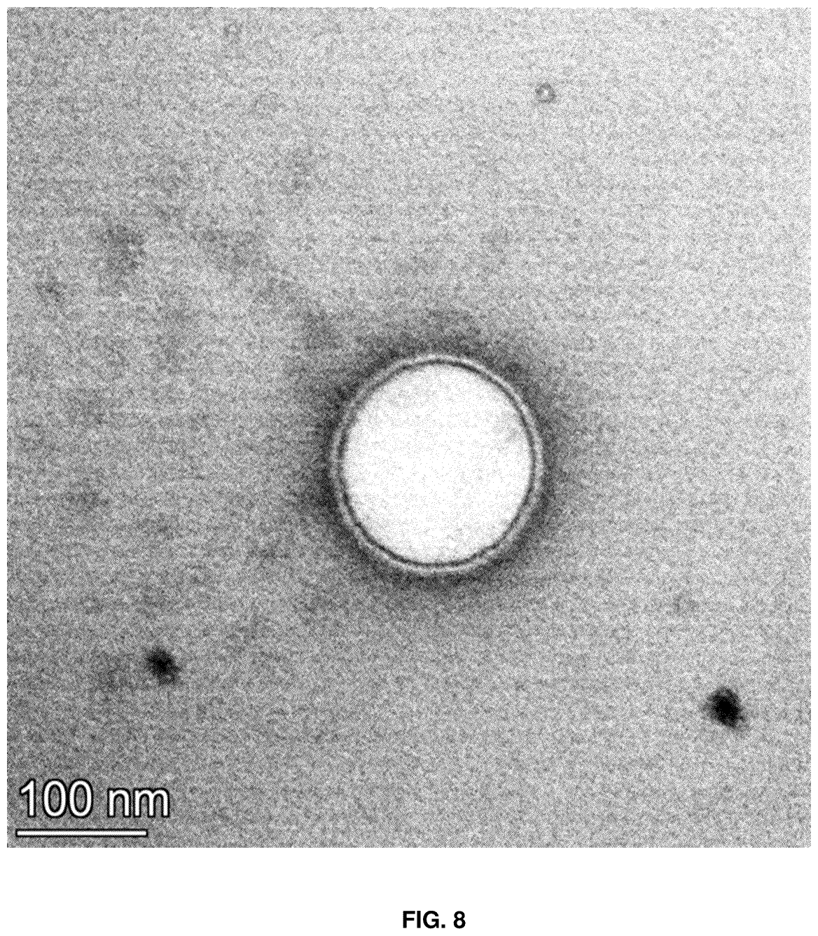

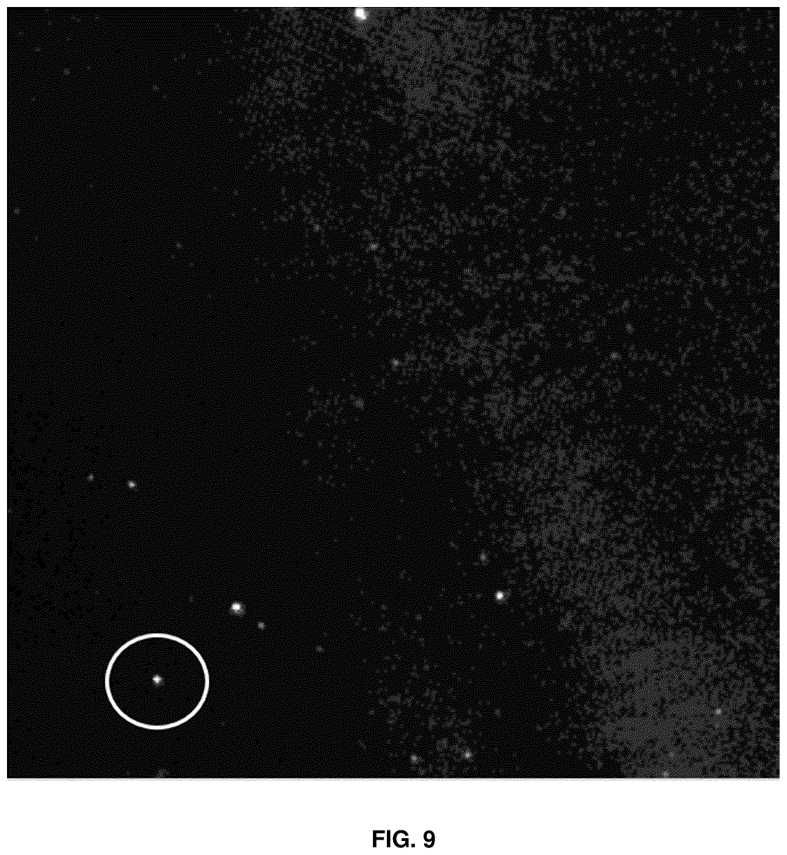

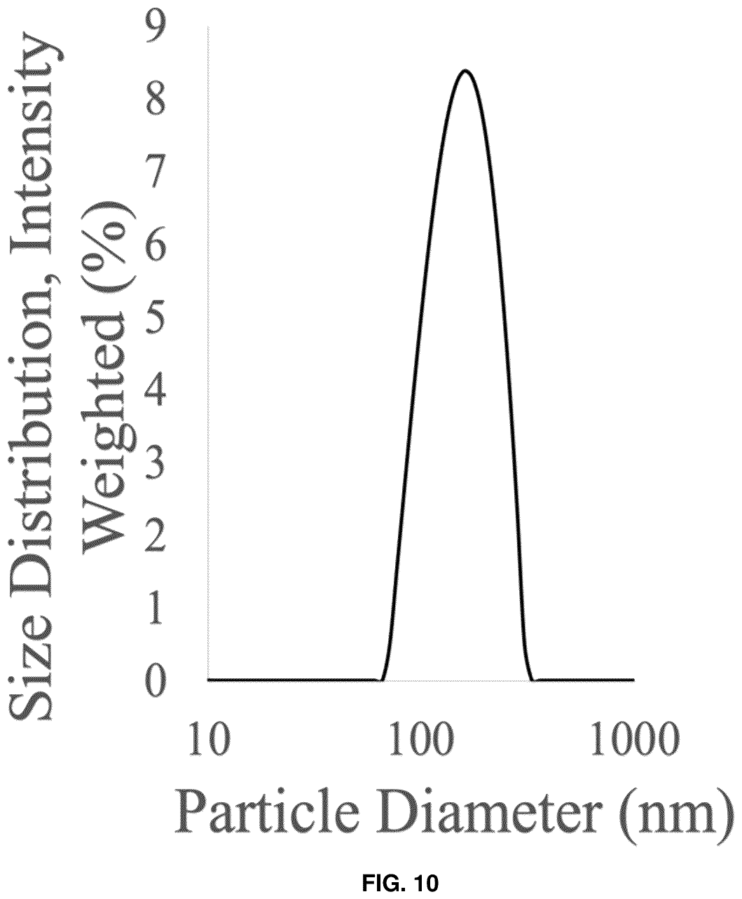

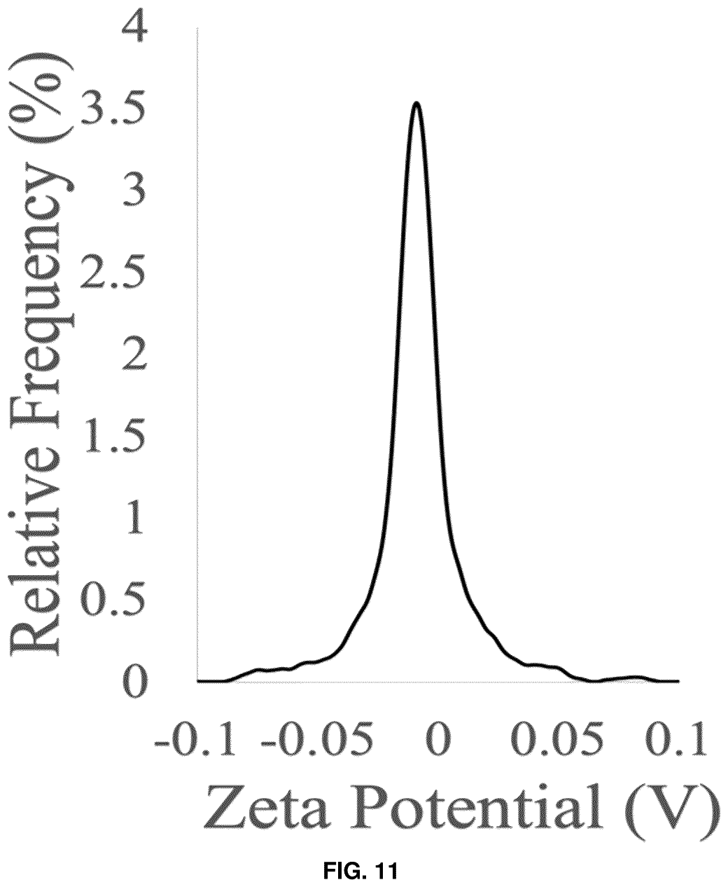

An automatic fraction collector as depicted in FIG. 1 was used to isolate exosomes from a mixture of exosomes and proteins. The pure exosomes were stained with DiO, a lipid fluorescent dye that can be measured using a fluorometer at excitation of 470 nm. Alexa Fluor 647 labeled secondary antibody, which can be measured at excitation of 637 nm, was added to the mixture of exosomes, protein, and DiO. 100 microliters of the dyed and labeled exosome and protein mixture was drawn in a 1 ml syringe and loaded onto the syringe pump. The appropriate program was selected, and the start button was pushed. After automatically loading sample on the column, 36 fractions were collected for analysis of exosome and protein. The fractions measurement was done using Qubit 3 fluorometer at 470 nm and 637 nm. The exosome peak was observed at fraction 7 and 9, whereas the protein peak was seen at fractions 13-15. Another free DiO dye peak was seen at fractions 16-18, showing the free DiO. These results are shown in FIG. 7. Therefore, it was possible to isolate stained exosomes from the protein and unstained free dye, which is a very useful application in conducting exosome studies. Furthermore, FIGS. 8-11 show the isolated pure exosome morphology, concentration, size, and zeta potentials. In sum, this example demonstrates that the automatic fraction collector is highly useful and advantageous in conducting exosome isolation.

Certain embodiments of the devices, systems, and methods disclosed herein are defined in the above examples. It should be understood that these examples, while indicating particular embodiments of the invention, are given by way of illustration only. From the above discussion and these examples, one skilled in the art can ascertain the essential characteristics of this disclosure, and without departing from the spirit and scope thereof, can make various changes and modifications to adapt the devices, systems, and methods described herein to various usages and conditions. Various changes may be made and equivalents may be substituted for elements thereof without departing from the essential scope of the disclosure. In addition, many modifications may be made to adapt a particular situation or material to the teachings of the disclosure without departing from the essential scope thereof.

What is claimed is:

1. An automatic fraction collector comprising:
a column;
an injection device configured to introduce a fluid into the column;
a nozzle in fluid communication with the column;
a pinch valve assembly configured to allow and prevent flow through the nozzle on command;
a sensor assembly comprising a body defining a channel therethrough, an IR emitter on a first side of the channel, and an IR detector on an opposing second side of the channel, wherein the sensor assembly is configured to sense liquid drops passing through the channel;
a carousel defining a plurality of housings each configured to hold a container; and
a controller in electrical communication with the sensor assembly and the pinch valve assembly;
wherein a fluid flow path is defined through the injection device, the column, the nozzle, the sensor assembly, and the carousel, wherein the controller is configured to move the carousel such that any one of the plurality of housings may be in the fluid flow path.

2. The automatic fraction collector of claim 1, wherein each of the column, the injection device, the nozzle, the pinch valve assembly, the sensor assembly, and the carousel is mounted on a support.

3. The automatic fraction collector of claim 1, wherein the pinch valve assembly comprises a pinch valve with an arm tip and a block, wherein the arm tip is configured to pinch the nozzle against the block.

4. The automatic fraction collector of claim 3, wherein the block comprises a curved indent.

5. The automatic fraction collector of claim 1, wherein the sensor assembly is disposed in the fluid flow path between the nozzle and the carousel.

6. The automatic fraction collector of claim 1, wherein the sensor assembly is not within or a part of the carousel.

7. The automatic fraction collector of claim 1, wherein the controller is configured to move a gear or wheel which drives movement of the carousel.

8. The automatic fraction collector of claim 1, wherein the controller is configured to count liquid drops sensed by the sensor assembly.

9. The automatic fraction collector of claim 1, further comprising a pump in electrical communication with the controller and configured to actuate the injection device, wherein the controller is configured to control introduction of the fluid from the injection device into the column.

10. The automatic fraction collector of claim 1, wherein the controller is configured to rotate the carousel based on the counted liquid drops.

11. The automatic fraction collector of claim 1, wherein the controller is configured to control the pinch valve assembly so as to restrict liquid drops flowing through the nozzle based on information received by the controller from the sensor assembly.

12. The automatic fraction collector of claim 1, further comprising a cleaning buffer container configured to house a cleaning buffer, and a washing buffer container configured to house a washing buffer, wherein each of the first external container and the second external container is in fluid communication with the column through tubing that bypasses the injection device.

13. The automatic fraction collector of claim 12, further comprising a cleaning buffer pump configured to pump the cleaning buffer from the cleaning buffer container into the column, and a washing buffer pump configured to pump the washing buffer from the washing buffer container into the column.

14. The automatic fraction collector of claim 13, wherein each of the cleaning buffer pump and the washing buffer pump is in electrical communication with the controller, such that the controller is configured to control pumping of the washing buffer and the cleaning buffer into the column.

15. A method of detecting a drop from a size exclusion chromatography column, the method comprising:
introducing a fluid to a size exclusion chromatography column;
allowing the fluid to pass through the size exclusion chromatography column, through a nozzle, and into a sensor assembly, the sensor assembly comprising a body defining a channel therethrough, an IR emitter on a first side of the channel, and an IR detector on an opposing second side of the channel; and
sensing a drop passing through the channel by detecting an interruption of IR light between the IR emitter and the IR detector, thereby detecting the drop.

16. The method of claim 15, further comprising preventing flow through the nozzle with a pinch valve assembly.

17. The method of claim 15, further comprising controlling the introduction of fluid with a controller in electrical communication with the sensor assembly based on information received from the sensor assembly.

18. The method of claim 15, further comprising collecting the drops in a container disposed in a carousel, and rotating the carousel automatically based on drops sensed by the sensor assembly.

19. The method of claim 15, further comprising injecting a cleaning buffer and/or a washing buffer into the size exclusion chromatography column automatically based on drops sensed by the sensor assembly.

20. A method of separating exosomes from protein with the automatic fraction collector of claim 1, the method comprising:
injecting a fluid comprising a sample mixture of exosomes and protein into the column, wherein the column is a size exclusion chromatography column;
allowing the sample mixture to separate in the column into exosome drops and protein drops; and
collecting the exosome drops in a container held in one of the plurality of housings.

21. A system comprising:
an apparatus comprising an injection device, a column, a nozzle, a sensor assembly, and a carousel in fluid communication;
a pinch valve assembly capable of permitting and restricting fluid flow through the nozzle; and
a controller in electrical communication with the injection device, the sensor assembly, the carousel, and the pinch valve assembly;
wherein the controller is configured to receive information from the sensor assembly to detect and count drops passing through the sensor assembly, and take any of the following actions based on the received information:
(i) move the carousel,
(ii) inject sample from the injection device into the column,
(iii) actuate the pinch valve assembly to restrict fluid flow through the nozzle,
(iv) display the information on a graphical user interface,
(v) illuminate a status indicator light,
(vi) load a sample from a sample container into the injection device,
(vii) load a washing buffer from a washing buffer container into the column, or
(viii) load a cleaning buffer from a cleaning buffer container into the column.

22. The system of claim 21, wherein the controller is configured to automatically sustain a flow of fluid by activating the injection device, moving the carousel, reloading the injection device, and using the sensor assembly to sense liquid drops flowing through a channel of the sensor assembly.
